(19) United States
(12) Patent Application Publication
(10) Pub. No.: US 2021/0222402 A1
(43) Pub. Date: Jul. 22, 2021

(54) HYDRAULIC SHIFT CONTROL SYSTEM

(71) Applicant: CNH Industrial America LLC, New Holland, PA (US)

(72) Inventor: Joshua Zimmerman, Willow Springs, IL (US)

(73) Assignee: CNH Industrial America LLC

(21) Appl. No.: 16/745,957

(22) Filed: Jan. 17, 2020

(51) Int. Cl. E02F 9/22; F16H 47/02; F15B 1/04; F16H 61/64

(52) U.S. Cl. CPC E02F 9/2246; F16H 47/02; F16H 2047/025; E02F 9/2292; F16H 61/64; F15B 1/04

(57) ABSTRACT

A work vehicle that includes a hydraulic system. The hydraulic system includes a hydraulic motor that generates rotational power for one or more wheels on the work vehicle. A hydraulic pump couples to the hydraulic motor. The hydraulic pump pumps hydraulic fluid to the hydraulic motor. A hydraulic shift control system controls shifting of the hydraulic system. The hydraulic shift control system includes a controller that controls a hydraulic motor volume of the hydraulic motor and a fluid volume pumped by the hydraulic pump to gradually change a speed of the work vehicle during a shift.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Hydraulic systems may be used on various pieces of equipment, such as on agricultural vehicles and implements. These hydraulic systems use a pressurized hydraulic fluid generated by a hydraulic pump to perform various tasks. In operation, the hydraulic pump pressurizes hydraulic fluid received from a hydraulic fluid source. Some work vehicles use this pressurized hydraulic fluid to actuate hydraulic motors that generate rotational power. The rotational power may then be used to drive wheels on a work vehicle. In some situations, the wheels may rotate tracks that are coupled to the wheels, such as on a skid steer. Unfortunately, shifting between speeds may cause the vehicle to lurch or jerk in response to rapid changes in motor volume with no change in hydraulic fluid flow delivered by the pump.

### BRIEF DESCRIPTION

This summary is provided to introduce a selection of concepts that are further described below in the detailed description. This summary is not intended to identify key or essential features of the claimed subject matter, nor is it intended to be used as an aid in limiting the scope of the claimed subject matter.

In one example, a work vehicle that includes a hydraulic system. The hydraulic system includes a hydraulic motor that generates rotational power for one or more wheels on the work vehicle. A hydraulic pump couples to the hydraulic motor. The hydraulic pump pumps hydraulic fluid to the hydraulic motor. A hydraulic shift control system controls shifting of the hydraulic system. The hydraulic shift control system includes a controller that controls a hydraulic motor volume of the hydraulic motor and a fluid volume pumped by the hydraulic pump to gradually change a speed of the work vehicle during a shift.

In another example, a hydraulic shift control system that includes a controller with a processor that executes computer executable instructions on a computer-readable medium. The controller gradually changes a speed of a work vehicle from a first speed to a second speed by gradually changing a hydraulic motor volume and a hydraulic pump volume. The controller receives a shift command and in response to the shift command shifts the work vehicle from the first speed to the second speed.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle that includes a hydraulic shift control system, in accordance with the present disclosure;

FIG. 2 is a schematic of an embodiment of a hydraulic shift control system that may be used in the work vehicle of FIG. 1, in accordance with the present disclosure;

FIG. 3 illustrates graphs of an embodiment of a hydraulic shift control system controlling an upshift, in accordance with the present disclosure;

FIG. 4 illustrates graphs of an embodiment of a hydraulic shift control system controlling a downshift, in accordance with the present disclosure; and

FIG. 5 illustrates graphs of an embodiment of a hydraulic shift control system controlling a downshift, in accordance with the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection, and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Agricultural or work vehicles may include one or more hydraulic systems that provide power to complete various tasks. These tasks may include loading, lifting, pushing, rotating, dozing, and even moving the work vehicle. For example, a work vehicle may include a hydraulic system that includes hydraulic motors that drive the wheels of the work vehicle. The wheels in turn couple to tracks which enable the work vehicle to traverse various types of terrain. Depending on the terrain and/or job, the operator may desire to drive the vehicle at different speeds. To change how fast the work vehicle travels, the operator may shift up or shift down. In response to a shifting command, the hydraulic system will either increase or decrease the motor volume and because the oil flow from the pump is unchanged this will cause the motor speed to either rapidly decrease or increase to allow the same oil flow through the new volume. This rapid change in the hydraulic motor volume can cause the vehicle to lurch or jerk as the hydraulic motor responds to the shift command. In order to reduce abrupt changes in hydraulic motor speeds from changing hydraulic motor volumes, the disclosure below describes a hydraulic shift control system. The hydraulic shift control system controls one or more hydraulic pumps to control the flow of hydraulic fluid to one or more hydraulic motors as the hydraulic motor volumes change, which reduces the lurching of the vehicle during the shift.

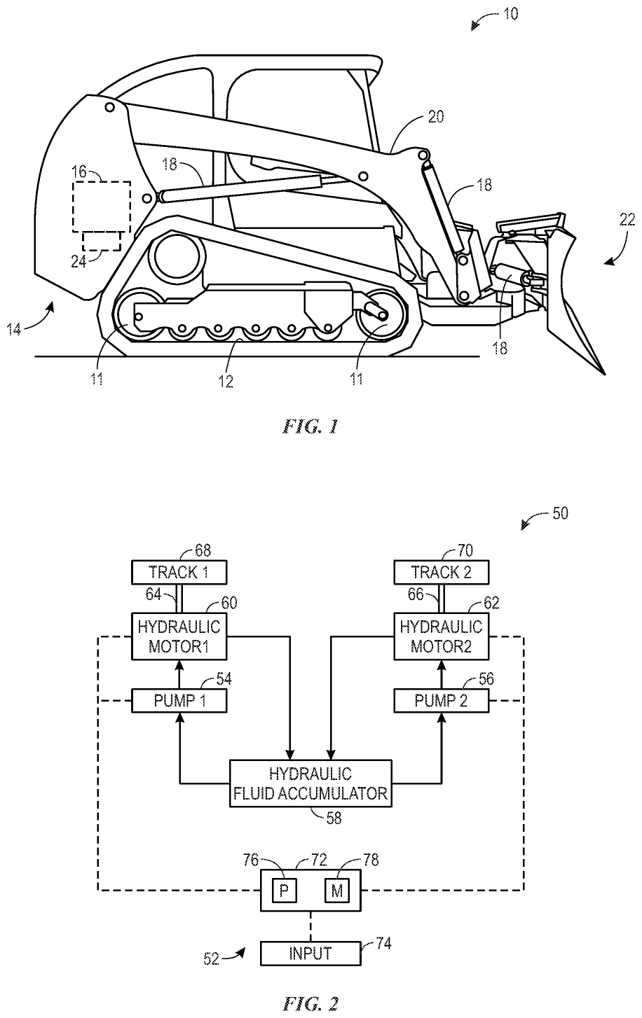

FIG. 1 is a side view of an embodiment of a work vehicle 10 (e.g., a skid steer). The work vehicle 10 may include wheels 11 and tracks 12 that enable the work vehicle 10 to move. The work vehicle 10 includes an engine 14 that provides power to a hydraulic system 16. The hydraulic system 16 in turn powers the wheels 11 which then rotate the tracks 12. The hydraulic system 16 may also power other systems on the work vehicle 10. For example, the hydraulic system 16 may provide power to hydraulic actuators 18 (e.g., hydraulic cylinders) that control operation of one or more arms 20 (e.g., booms). The arms 20 couple to tools 22 that enable the work vehicle to perform various tasks. For example, forks, buckets, plows, blades, among others may be attached to the arms 20. Each of these tools enable the work vehicle 10 to perform one or more tasks such as loading, dozing, etc. The hydraulic system 16 may also include one or more hydraulic pumps and one or more hydraulic motors that provide power to the wheels 11 on the work vehicle 10. In order to reduce or block lurching of the work vehicle 10 as it shifts, the work vehicle 10 includes a hydraulic shift control system 24. As will be explained below, the hydraulic shift control system 24 controls operation of one or more hydraulic pumps and one or more hydraulic motors on the work vehicle 10 to reduce abrupt changes in speed of the work vehicle 10 while shifting.

FIG. 2 is a schematic of an embodiment of a hydraulic system 50 and hydraulic shift control system 52 that may be used in a work vehicle (e.g., work vehicle of FIG. 1). The hydraulic system 50 may include a first hydraulic pump 54 and a second hydraulic pump 56 that receives hydraulic fluid from a hydraulic accumulator or source 58. The first pump 54 and the second pump 56 supply hydraulic fluid to respective first and second hydraulic motors 60, 62. The hydraulic motors 60, 62 have discrete volumes associated with respective discrete speed shifts (e.g., two speed shifts). As the first and second hydraulic motors 60, 62 receive hydraulic fluid they drive rotation of respective first and second wheels 64, 66. The wheels 64, 66 in turn may couple to and rotate first and second vehicle tracks 68 and 70 enabling the work vehicle to move. It should be understood, that the hydraulic system 50 may include a different number of pumps, hydraulic motors, wheels, and/or tracks (e.g., 1, 2, 3, 4, or more).

In order to reduce or block lurching or jerking of the work vehicle as it shifts, the hydraulic shift control system 52 couples to the hydraulic system 50. More specifically, the hydraulic shift control system 52 couples to and controls operation of the first and second pumps 54, 56 and the first and second hydraulic motors 60, 62. The hydraulic shift control system 52 controls operation of the hydraulic pumps 54, 56 and the hydraulic motors 60, 62 to reduce abrupt changes in the speed of the work vehicle. In other words, the hydraulic shift control system 52 enables a gradual increase and decrease in the speed of the work vehicle in response to a shift signal. The hydraulic shift control system 52 includes a controller 72 that receives a shift signal from an input 74. The input 74 may be a joystick, touchscreen, lever, button(s), among others. The controller 72 receives and processes this signal from the input 74 and executes instructions stored on a memory 78 to control operation of the pumps 54, 56 and the hydraulic motors 60, 62. For example, the controller 52 may increase or decrease the flow rate of hydraulic fluid produced by the pumps 54, 56 and/or control the change in volume of the hydraulic motors 60, 62 to change the speed of the work vehicle in response to the shift signal.

The processor 76 may be a microprocessor that executes software that enables control of the hydraulic system 50. The processor 76 may include multiple microprocessors, one or more “general-purpose” microprocessors, one or more special-purpose microprocessors, and/or one or more application specific integrated circuits (ASICs), field-programmable gate arrays (FPGAs), or some combination thereof. For example, the processor 76 may include one or more reduced instruction set computer (RISC) processors.

The memory 78 may include a volatile memory, such as random access memory (RAM), and/or a nonvolatile memory, such as read-only memory (ROM). The memory 78 may store a variety of information and may be used for various purposes. For example, the memory 78 may store processor executable instructions, such as firmware or software, for the processor 76 to execute. The memory 78 may include ROM, flash memory, a hard drive, or any other suitable optical, magnetic, or solid-state storage medium or a combination thereof. The memory 78 may store data, instructions, and any other suitable data.

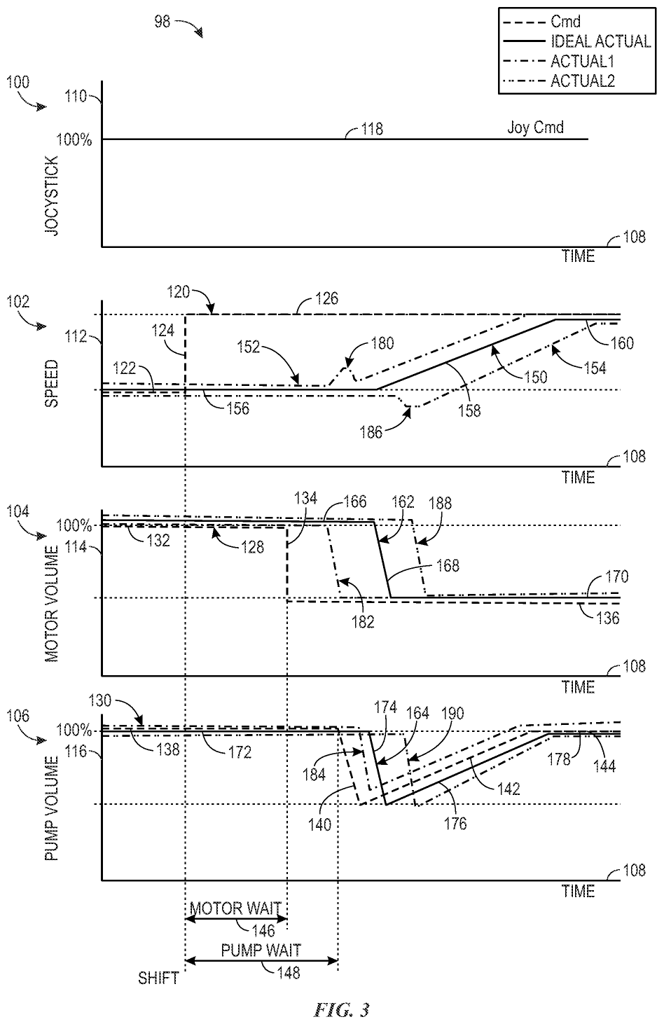

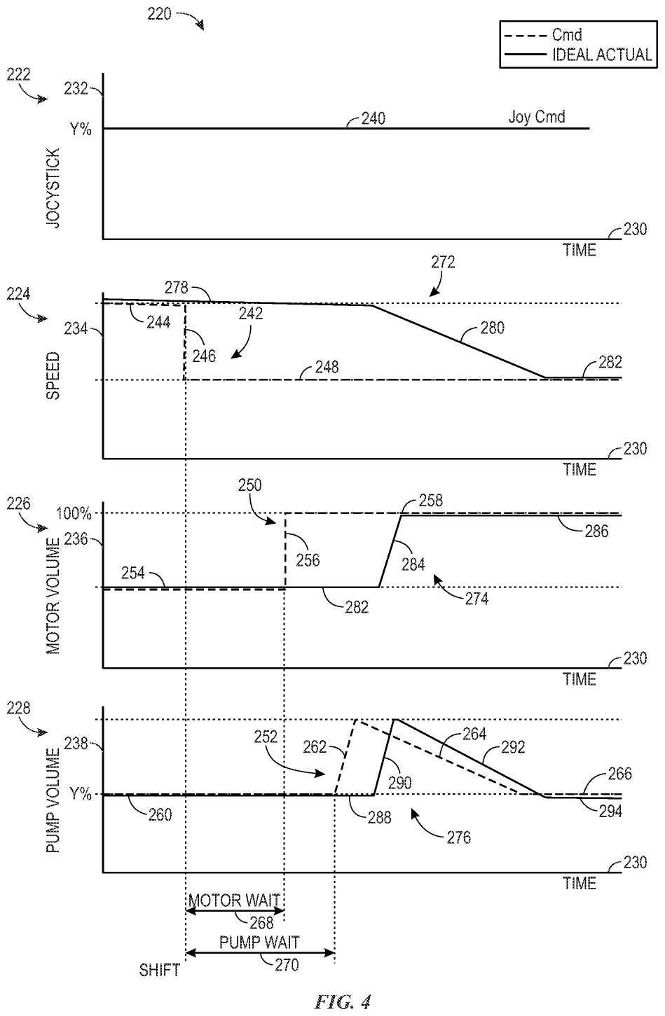

FIG. 3 illustrates graphs 98 of the hydraulic shift control system controlling an upshift. As illustrated, there are four graphs 100, 102, 104, and 106. The graphs 98 illustrate different input or responses with respect to time, x-axis 108. The first graph 100 illustrates an input command (e.g., joystick command) relative to time. The first graph 100 includes a y-axis 110 for the input command (e.g., joystick command) and the x-axis 108 for time. The second graph 102 illustrates change in the speed of the work vehicle relative to time. The second graph 102 includes a y-axis 112 for speed and an x-axis 108 for time. The third graph 104 illustrates changes in volume of the hydraulic motor relative to time. The third graph 104 includes a y-axis 114 for the motor volume and an x-axis 108 for time. The fourth graph 106 illustrates a change in the volume of hydraulic fluid pumped relative to time. The fourth graph 106 includes a y-axis 116 for the pump volume and an x-axis 108 for time.

These graphs 100, 102, 104, and 106 includes various lines that illustrate the response of a hydraulic system to commands that change pump volume and motor volume and how changes in pump volume and motor volume change the speed of a work vehicle during in upshift. The first graph 100 includes line 118 that illustrates a command generated by an input device (e.g., touch screen, button, joystick, lever) to increase the speed of the work vehicle. The hydraulic shift control system (e.g., controller) receives this signal and generates a speed command to increase the speed of the work vehicle. This speed command is illustrated by line 120. As illustrated, the speed command line 120 includes a first steady state portion 122, a transition portion 124, and a second steady state portion 126. The first steady state portion 122 illustrates the previous speed command associated with a previous speed of the work vehicle. Upon receiving a new speed input (e.g., from an input device) the speed command line 120 increases from the first speed to a second speed (e.g., jumps) along the transition portion 124. After changing the speed command, the speed command line 120 continues with the second steady state portion 126 associated with the new desired speed of the work vehicle.

In response to the speed command, the hydraulic shift control system generates a motor volume command and a pump volume command. These commands are sent to the respective hydraulic motor(s) and hydraulic pump(s), which change the volume of the hydraulic motor(s) and the volume of hydraulic fluid pumped by the hydraulic pump(s). The motor volume command is illustrated by line 128 and the pump volume command is illustrated by line 130. As illustrated, the motor volume command line 128 includes a first steady state portion 132, a transition portion 134, and a second steady state portion 136. The first steady state portion 132 illustrates the previous motor volume that enables the previous speed of the work vehicle. Upon receiving a new speed input (e.g., from an input device) the motor volume command line 128 decreases from the first volume to a second volume (e.g., jumps) along the transition portion 134. The motor volume command line 128 then continues with the second steady state portion 136 associated with the new desired motor volume.

The pump volume command line 130 includes a first steady state portion 138, a first transition portion 140, a second transition portion 142, and a second steady state portion 144. The first steady state portion 138 illustrates the previous pump volume that enables the previous speed of the work vehicle. Upon receiving a new speed input (e.g., from an input device) the motor volume command line 130 decreases from the first volume to a second volume along the transition portion 140. As illustrated, this change may be a rapid change but is not a jump. For example, a rapid linear change from a first pump volume to a second pump volume. After reaching the second pump volume, the pump volume command line 130 transitions from the second pump volume to the first pump volume along the second transition portion 142. The second transition portion 142 may be a linear signal to increase the pump volume from the second pump volume to the first pump volume. The motor volume command line 130 then continues with the second steady state portion 144 associated with the first pump volume.

In some embodiments, there may be a delay between the change in the speed command 120 (i.e., the transition portion 124) and the change in the motor volume command 128 (i.e., the transition portion 134) and the pump volume command 130 (i.e., the start of the first transition 140). The motor wait delay is labeled 146 and the pump wait delay is labeled 148. In some embodiments, the difference between the motor wait delay 146 and the pump wait delay 148 may be zero. In other embodiments, there may be a difference between the motor wait delay 146 and the pump wait delay 148 depending on the whether the hydraulic motor(s) or the hydraulic pump(s) take longer to respond to the speed command. As will be explained below, simultaneous changes in the motor volume and the pump volume enable a smooth upshift from a first speed to a second speed.

As explained above, the motor volume command and pump volume commands are sent to the respective hydraulic motor(s) and hydraulic pump(s), which change the volume of the hydraulic motor(s) and the volume of hydraulic fluid pumped by the hydraulic pump(s). The changes in the volume of the hydraulic motors and the volume pumped by hydraulic pumps changes the speed of the work vehicle as well as the abruptness of the shift. The graphs in FIG. 3 illustrate three speed response lines that occur in response to changes of the motor volume and the pump volume. These speed lines are illustrated with lines 150, 152, and 154.

The first speed line 150 includes a first steady state portion 156, a transition portion 158, and a second steady state portion 160. The first steady state portion 156 illustrates the operation of the work vehicle at a first speed. Once the speed command is produced the hydraulic motor(s) and hydraulic pump(s) change operation enabling an increase in the speed of the work vehicle from the first speed illustrated by the first steady state portion 156 to the second speed illustrated by the second steady state portion 160. As illustrated, the transition portion 158 illustrates the change in speed between the first and second speeds. The transition portion 158 may linear wherein the speed of the work vehicle gradually increases from the first speed to the second speed. In other words, the work vehicle may not lurch or jerk as it upshifts and transitions from the first speed to the second speed.

In order to produce the smooth transition between speeds illustrated by the transition portion 158 of the speed line 150, the hydraulic shift control system rapidly changes the pump volume to counter discrete motor volume transitions. These changes are illustrated by the motor volume line 162 and the pump volume line 164. The motor volume line 162 illustrates the changes in motor volume in response to the motor volume commands. As illustrated, the motor volume line 162 includes a first steady state portion 166, a transition portion 168, and a second steady state portion 170. At the first steady state portion 166 the motor volume is at a first volume (e.g., 100%) which then transitions to a second volume (e.g., 50%) of the second steady state portion 170. The transition between these two volumes is illustrated by the transition portion 168. As illustrated, the transition portion 168 (e.g., rate) is gradual enabling a gradual change from the first volume to the second volume.

The pump volume line 164 illustrates the change in pump volume in response to the pump volume commands. The pump volume line 164 includes a first steady state portion 172, a first transition portion 174, a second transition portion 176, and a second steady state portion 178. In order to block or reduce the rapid increase in the hydraulic motor speed due to the same fluid flow through a smaller hydraulic motor volume, the hydraulic pump may decrease the volume of hydraulic fluid pumped at the same time as the motor volume decreases, illustrated by the first transition portion 174 (e.g., rate). This simultaneous change reduces or blocks lurching of the work vehicle as the motor transitions from the first volume to the second volume in preparation for increased speed. In some embodiments, the rate of the motor volume change illustrated by the transition portion 168 is equal to the change in the pump volume rate illustrated by the first transition portion 174. After reducing the volume of hydraulic fluid from the first volume to the second volume, the hydraulic pump gradually (e.g., progressively) increases the pump volume from the second pump volume back to the first pump volume, illustrated by the second transition portion 176 (e.g., rate). In some embodiments, the pump volume rate illustrated by the first transition portion 174 may be greater than the pump volume rate of the second transition portion 176. The increase in pump volume through the reduced motor volume (e.g., second motor volume) increases the speed of the work vehicle illustrated by the transition portion 158 of the speed line 150. In this way, the hydraulic shift control system gradually increases the speed of the work vehicle from a first speed to a second speed without lurching or jerking the work vehicle. It should be understood that the hydraulic shift control system may control the aggressiveness of the upshift by controlling how rapidly the motor volume and pump volumes changes (e.g., the slope of the transition portions 168, 174, and 176).

As explained above, the simultaneous change in the motor volume and pump volume creates a smooth upshift and speed increase. However, if the motor volume and pump volume do not change simultaneously the work vehicle may jerk. For example, if the volume through the hydraulic motor is reduced by half but the hydraulic fluid flow remains unchanged, the hydraulic motor will instantaneously or near instantaneously spin twice as fast. Accordingly, to accommodate the change in motor volume, the hydraulic shift control system changes the amount of fluid pumped by the hydraulic pump or in other words the pump volume in response to changes in the motor volume. The speed line 152 illustrates a curved portion 180 where the vehicle rapidly increases in speed before again decreasing in speed. This is caused by a motor volume decreasing before the pump volume decreases. This is illustrated by motor volume line 182 and pump volume line 184. Similarly, the work vehicle may decrease in speed below an initial or first speed during the upshift if the motor volume and pump volume do not change simultaneously. As illustrated, speed line 154 includes a curved portion 186 (e.g., dip) where the speed of the work vehicle dips below an initial or first speed. This is caused by the pump volume decreasing before a decrease in the motor volume. A constant flowrate of hydraulic fluid flowing through an increasing hydraulic motor volume decreases the rotational speed of the hydraulic motor. This is illustrated by the motor volume line 188 and the pump volume line 190.

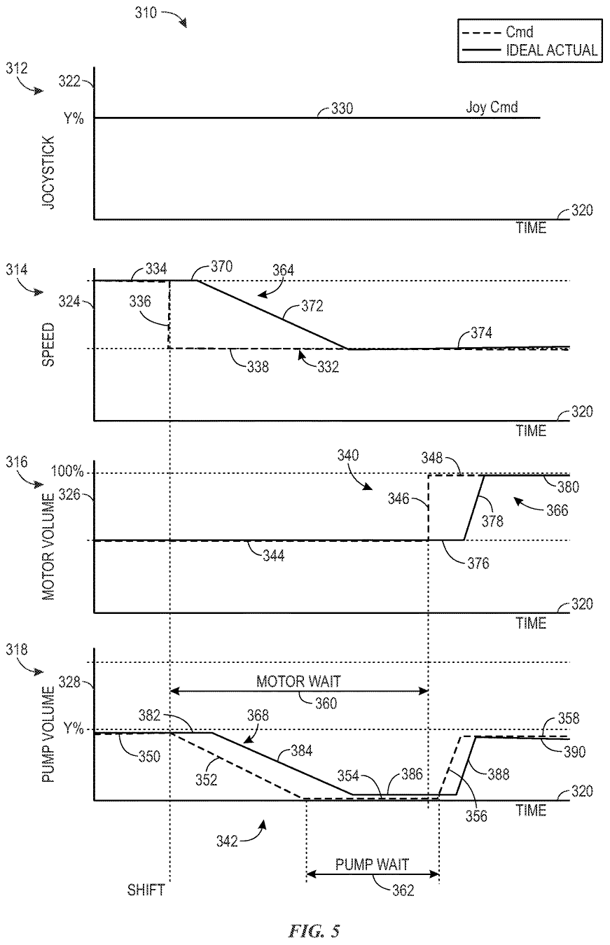

FIG. 4 illustrates graphs 220 of a hydraulic control system controlling a downshift. As illustrated, there are four graphs 222, 224, 226, and 228. The graphs 220 illustrate different input or responses with respect to time, x-axis 230. The first graph 222 illustrates an input command (e.g., joystick command) relative to time. The first graph 222 includes a y-axis 232 for the input command (e.g., joystick command) and an x-axis 230 for time. The second graph 224 illustrates changes in speed of the work vehicle relative to time. The second graph 224 includes a y-axis 234 for speed and an x-axis 230 for time. The third graph 226 illustrates changes in volume of the hydraulic motor relative to time. The third graph 226 includes a y-axis 236 for the motor volume and an x-axis 230 for time. The fourth graph 228 illustrates a change in the volume of hydraulic fluid pumped relative to time. The fourth graph 228 includes a y-axis 238 for the pump volume and an x-axis 230 for time.

These graphs 222, 224, 226, and 228 include various lines that illustrate the response of a hydraulic system to commands that change pump volume and motor volume and how changes in pump volume and motor volume change the speed of a work vehicle during a downshift. The first graph 222 includes line 240 that illustrates a command generated by an input device (e.g., touch screen, button, joystick, lever) to decrease the speed of the work vehicle. The hydraulic shift control system (e.g., controller) receives this signal and generates a speed command to decrease the speed of the work vehicle. This speed command is illustrated by line 242. As illustrated, the speed command line 242 includes a first steady state portion 244, a transition portion 246, and a second steady state portion 248. The first steady state portion 244 illustrates the previous speed command associated with the previous speed of the work vehicle. Upon receiving a new speed input (e.g., from an input device) the speed command line 242 decreases from the first speed to a second speed (e.g., jumps) along the transition portion 246. After changing the speed command, the speed command line 242 continues with the second steady state portion 248 associated with the new desired speed of the work vehicle.

In response to the speed command, the hydraulic shift control system generates a motor volume command and a pump volume command. These commands are sent to the respective hydraulic motor(s) and hydraulic pump(s), which change the volume of the hydraulic motor(s) and the volume of hydraulic fluid pumped by the hydraulic pump(s). The motor volume command is illustrated by line 250 and the pump volume command is illustrated by line 252. As illustrated, the motor volume command 250 includes a first steady state portion 254, a transition portion 256, and a second steady state portion 258. The first steady state portion 254 illustrates the previous motor volume that enables the previous speed of the work vehicle. Upon receiving a new speed input (e.g., from an input device) the motor volume command 250 increases from the first volume to a second volume (e.g., jumps) along the transition portion 256. The motor volume command 250 then continues with the second steady state portion 258 associated with the new desired motor volume.

The pump volume command line 252 includes a first steady state portion 260, a first transition portion 262, a second transition portion 264, and a second steady state portion 266. The first steady state portion 260 illustrates the previous pump volume that enables the previous speed of the work vehicle. Upon receiving a new speed input (e.g., from an input device) the pump volume command 252 increases from the first volume to a second volume along the first transition portion 262. As illustrated, this change may be a rapid change but is not a jump. For example, the first transition portion 262 may be a rapid linear change from a first pump volume to a second pump volume. After reaching the second pump volume, the pump volume command 252 transitions from the second pump volume to the first pump volume along the second transition portion 264. The second transition portion 264 may be a linear signal to decrease the pump volume from the second pump volume to the first pump volume. The pump volume command 252 then continues with the second steady state portion 266 associated with the first pump volume.

In some embodiments, there may be a delay between the change in the speed command 242 (i.e., the transition portion 246) and the change in the motor volume command 250 (i.e., the transition portion 256) and the pump volume command 252 (i.e., the start of the first transition 262). The motor wait delay is labeled 268 and the pump wait delay is labeled 270. In some embodiments, the difference between the motor wait delay 268 and the pump wait delay 270 may be zero. In other embodiments, there may be a difference between the motor wait delay 268 and the pump wait delay 270 depending on whether the hydraulic motor(s) or the hydraulic pump(s) take longer to respond to the speed command. As will be explained below, simultaneous changes in the motor volume and the pump volume enable a smooth downshift from a first speed to a second speed.

As explained above, the motor volume command and pump volume commands are sent to the respective hydraulic motor(s) and hydraulic pump(s), which change the volume of the hydraulic motor(s) and the volume of hydraulic fluid pumped by the hydraulic pump(s). The changes in the volume of the hydraulic motors and the volume pumped by hydraulic pumps change the speed of the work vehicle and how smoothly it shifts. The graphs 220 in FIG. 4 illustrate a speed response line 272, a motor volume line 274, and a pump volume line 276.

The speed line 272 includes a first steady state portion 278, a transition portion 280, and a second steady state portion 282. The first steady state portion 278 illustrates the operation of the work vehicle at the first speed. Once the speed command is produced the hydraulic motor(s) and hydraulic pump(s) change operation enabling a decrease in the speed of the work vehicle from the first speed illustrated in the first steady state portion 278 to the second speed illustrated by the second steady state portion 282. As illustrated, the transition portion 280 illustrates the change in speed between the first and second speeds. The transition portion 280 may linear wherein the speed of the work vehicle gradually increases from the first speed to the second speed. In other words, the work vehicle may not lurch or jerk as it downshifts and transitions from the first speed to the second speed.

In order to produce the smooth transition between speeds illustrated by the transition portion 280 of the speed line 272, the hydraulic shift control system gradually (e.g., progressively) changes the pump volume to counter the rapid change in motor volume during the shift. These changes are illustrated by the motor volume line 274 and the pump volume line 276. The motor volume line 274 illustrates the changes in motor volume in response to the motor volume commands. As illustrated, the motor volume line 274 includes a first steady state portion 282, a transition portion 284, and a second steady state portion 286. At the first steady state portion 282 the motor volume is at a first volume (e.g., 50%) and at a second volume (e.g., 100%) at the second steady state portion 286. The transition between these two volumes is illustrated by the transition portion 284 (e.g., rate). As illustrated, the transition portion 284 may be gradual enabling a gradual change from the first volume to the second volume. By increasing the volume of the hydraulic motor, the hydraulic motor may decrease the speed of the hydraulic motor. However, if this change in not accompanied by a corresponding change in hydraulic fluid flow the decrease in speed may be abrupt or sudden. For example, if the volume of the hydraulic motor is doubled but the hydraulic fluid flow remains unchanged, the hydraulic motor will spin half as fast. Accordingly, to accommodate the change in motor volume, the hydraulic shift control system changes the amount of fluid pumped by the hydraulic pump or in other words the pump volume.

The pump volume line 276 illustrates the change in pump volume in response to the pump volume commands. The pump volume line 276 includes a first steady state portion 288, a first transition portion 290, a second transition portion 292, and a second steady state portion 294. In order to block or reduce the rapid decrease in rotations by the hydraulic motor as the hydraulic motor increases in volume, the hydraulic pump may increase the volume of hydraulic fluid pumped at the same time the motor volume increases, illustrated by the first transition portion 290 (e.g., rate). This simultaneous change reduces or blocks lurching of the work vehicle as the hydraulic motor transitions from the first volume to the second volume in preparation for a decrease in speed. In some embodiments, the rate of the motor volume change illustrated by the transition portion 284 is equal to the change in the pump volume rate illustrated by the first transition portion 290. After increasing the volume of hydraulic fluid from the first volume to the second volume, the hydraulic pump gradually (e.g., progressively) decreases the pump volume from the second pump volume back to the first pump volume, illustrated by the second transition portion 292 (e.g., rate). In some embodiments, the pump volume rate illustrated by the first transition portion 290 may be greater than the pump volume rate of the second transition portion 292. The decrease in pump volume through the increased motor volume (e.g., second motor volume) gradually decreases the speed of the work vehicle illustrated by the transition portion 280 of the speed line 272. In this way, the hydraulic shift control system gradually decreases the speed of the work vehicle from a first speed to a second speed without lurching or jerking the work vehicle. It should be understood that the hydraulic shift control system may control the aggressiveness of the upshift by controlling how rapidly the pump volumes changes. As explained above, the simultaneous change in the motor volume and pump volume neutralizes the shift and then the smooth change in pump volume creates a smooth downshift and speed decrease. However, if the motor volume and pump volume do not change simultaneously the work vehicle may jerk or lurch.

FIG. 5 illustrates graphs 310 of a hydraulic shift control system controlling a downshift. As illustrated, there are four graphs 312, 314, 316, and 318. The graphs 310 illustrate different input or responses with respect to time, x-axis 320. The first graph 312 illustrates an input command (e.g., joystick command) relative to time. The first graph 312 includes a y-axis 322 for the input command (e.g., joystick command) and an x-axis 320 for time. The second graph 314 illustrates a change in speed of the work vehicle relative to time. The second graph 314 includes a y-axis 324 for speed and an x-axis 320 for time. The third graph 316 illustrates a change in volume of the hydraulic motor relative to time. The third graph 316 includes a y-axis 326 for the motor volume and an x-axis 320 for time. The fourth graph 318 illustrates a change in the volume of hydraulic fluid pumped relative to time. The fourth graph 318 includes a y-axis 328 for the pump volume and an x-axis 320 for time.

These graphs 312, 314, 316, and 318 include various lines that illustrate the response of a hydraulic system to commands that change pump volume and motor volume and how changes in pump volume and motor volume change the speed of a work vehicle during a downshift. The first graph 312 includes line 330 that illustrates a command generated by an input device (e.g., touch screen, button, joystick, lever) to increase the speed of the work vehicle. The hydraulic shift control system (e.g., controller) receives this signal and generates a speed command to decrease the speed of the work vehicle. This speed command is illustrated by line 332. As illustrated, the speed command 332 includes a first steady state portion 334, a transition portion 336, and a second steady state portion 338. The first steady state portion 334 illustrates the previous speed command associated with the previous speed of the work vehicle. Upon receiving a new speed input (e.g., from an input device) the speed command 332 decreases from the first speed to a second speed (e.g., jumps) along the transition portion 336. After changing the speed command, the speed command 332 continues with the second steady state portion 338 associated with the new desired speed of the work vehicle.

In response to the speed command, the hydraulic shift control system generates a motor volume command and a pump volume command. These commands are sent to the respective hydraulic motor(s) and hydraulic pump(s), which change the volume of the hydraulic motor(s) and the volume of hydraulic fluid pumped by the hydraulic pump(s). The motor volume command is illustrated by line 340 and the pump volume command is illustrated by line 342. As illustrated, the motor volume command 340 includes a first steady state portion 344, a transition portion 346, and a second steady state portion 348. The first steady state portion 344 illustrates the previous motor volume that enables the previous speed of the work vehicle. Upon receiving a new speed input (e.g., from an input device) the motor volume command 340 increases from the first volume to a second volume (e.g., jumps) along the transition portion 346. The motor volume command 340 then continues with the second steady state portion 348 associated with the new desired motor volume.

The pump volume command line 342 includes a first steady state portion 350, a first transition portion 352, a second steady state portion 354, a second transition portion 356, and a third steady state portion 358. The first steady state portion 350 illustrates the previous pump volume that enables the previous speed of the work vehicle. Upon receiving a new speed input (e.g., from an input device) the pump volume command 342 decreases from the first volume to a second volume along the first transition portion 352 (e.g. rate). As illustrated, this change may be a gradual change (e.g., linear). After reaching the second pump volume, the pump volume command 342 transitions to the second steady state portion 354. The pump volume command 342 then again increases from the second pump volume to the first pump volume along the second transition portion 356. The second transition portion 356 may be a linear signal to increase the pump volume from the second pump volume to the first pump volume. The motor volume command 342 then continues with the third steady state portion 358 associated with the second pump volume.

In some embodiments, there may be a delay between the change in the speed command 332 (i.e., the transition portion 336) and the change in the motor volume command 340 (i.e., the transition portion 346) and the pump volume command 342 (i.e., the end of the first transition 352 and the start of the second transition 356). The motor wait delay is labeled 360 and the pump wait delay is labeled 362. In some embodiments, the difference between the motor wait delay 360 and the pump wait delay 362 may be zero. In other embodiments, there may be a difference between the motor wait delay 360 and the pump wait delay 362 depending on the whether the hydraulic motor(s) or the hydraulic pump(s) take longer to respond to the speed command. As will be explained below, simultaneous changes in the motor volume and the pump volume enable a smooth downshift from a first speed to a second speed.

As explained above, the motor volume commands and pump volume commands are sent to the respective hydraulic motor(s) and hydraulic pump(s), which change the volume of the hydraulic motor(s) and the volume of hydraulic fluid pumped by the hydraulic pump(s). The changes in the volume of the hydraulic motors and the volume pumped by hydraulic pumps changes the speed of the work vehicle and how it shifts. The graphs 310 in FIG. 5 illustrate a speed response line 364, a motor volume line 366, and a pump volume line 368.

The speed line 364 includes a first steady state portion 370, a transition portion 372, and a second steady state portion 374. The first steady state portion 370 illustrates the operation of the work vehicle at a first speed. Once the speed command is produced the hydraulic motor(s) and hydraulic pump(s) change operation enabling a decrease in the speed of the work vehicle from the first speed illustrated in the first steady state portion 370 to the second speed illustrated by the second steady state portion 374. As illustrated, the transition portion 372 illustrates the change in speed between the first and second speeds. The transition portion 372 may be linear wherein the speed of the work vehicle gradually decreases from the first speed to the second speed. In other words, the work vehicle may not lurch or jerk as it downshifts and transitions from the first speed to the second speed.

In order to produce the smooth transition between speeds illustrated by the transition portion 372 of the speed line 364, the hydraulic shift control system gradually (e.g., progressively) changes the pump volume prior to the motor shift and then rapidly changes the pump volume during the motor shift to counter the change in motor volume. These changes are illustrated by the motor volume line 366 and the pump volume line 368. The motor volume line 366 illustrates the changes in motor volume in response to the motor volume commands. As illustrated, the motor volume line 366 includes a first steady state portion 376, a transition portion 378, and a second steady state portion 380. At the first steady state portion 376 the motor volume is at a first volume (e.g., 50%) which then transitions to a second volume (e.g., 100%) of the second steady state portion 380. The transition between these two volumes is illustrated by the transition portion 378 (e.g. rate). As illustrated, the transition portion 378 is gradual (e.g., linear) enabling a gradual change from the first volume to the second volume. By changing the volume of the hydraulic motor, the hydraulic motor may decrease the speed of the hydraulic motor (e.g., rapidly) if the hydraulic fluid flow is not also adjusted. For example, if the volume of the hydraulic motor is doubled but the hydraulic fluid flow remains unchanged, the hydraulic motor will rapidly change to spinning half as fast. Accordingly, to accommodate the change in motor volume, the hydraulic shift control system changes the amount of fluid pumped by the hydraulic pump or in other words the pump volume.

The pump volume line 368 illustrates the change in pump volume in response to the pump volume command 342. The pump volume line 368 includes a first steady state portion 382, a first transition portion 384, a second steady state portion 386, a second transition portion 388, and a third steady state portion 390. In order to block or reduce the rapid decrease in the speed of the hydraulic motor as the hydraulic motor increases in volume, the hydraulic pump may first decrease the volume of hydraulic fluid pumped, illustrated by the first transition portion 384 (e.g., rate). This gradual reduction in flow through the hydraulic motor decreases the speed of the hydraulic motor to reduce or block lurching of the work vehicle. After decreasing the volume of hydraulic fluid from the first volume to the second volume, the hydraulic pump transitions to the second steady state portion 386 as the hydraulic pumps waits for the motor volume command 340 to change. After the second steady state portion 386, the hydraulic pump receives the command to increase the pump volume. The pump volume increases as illustrated by the second transition portion 388. The increase in pump volume occurs as the motor volume increases. In some embodiments, the rate of the motor volume change illustrated by the transition portion 378 is equal to the change in the pump volume rate illustrated by the second transition portion 388. The rotational speed of the hydraulic motor therefore remains unchanged. After reaching the second pump volume, the hydraulic pump maintains constant pump volume illustrated by the third steady state line 390. Furthermore, in some embodiments, the pump volume rate illustrated by the first transition portion 384 may be less than the pump volume rate of the second transition portion 388. In this way, the hydraulic shift control system gradually decreases the speed of the work vehicle from a first speed to a second speed without lurching or jerking the work vehicle. It should be understood that the hydraulic shift control system may control the aggressiveness of the downshift by controlling how rapidly the pump volumes changes.

Technical effects of the invention include a hydraulic shift control system that enables a work vehicle to smoothly change speeds as it upshifts or downshifts. The hydraulic shift control system enables the smooth shift by simultaneously controlling the hydraulic fluid flow through a hydraulic pump and a volume of a hydraulic motor.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A work vehicle, comprising:
a hydraulic system, comprising:
a hydraulic motor configured to generate rotational power for one or more wheels on the work vehicle; and
a hydraulic pump coupled to the hydraulic motor, wherein the hydraulic pump is configured to pump hydraulic fluid to the hydraulic motor; and
a hydraulic shift control system configured to control shifting of the hydraulic system, the hydraulic shift control system comprising a controller having a processor and a memory, wherein the controller is configured to:
receive a shift command;
produce a motor volume command and a pump volume command in response to the shift command; and
control a hydraulic motor volume of the hydraulic motor and a hydraulic pump volume of the hydraulic pump to shift a speed of the work vehicle, in response to the shift command, from a first speed to a second speed;
wherein the motor volume command is configured to control the hydraulic motor to change the hydraulic motor volume at a first rate from a first hydraulic motor volume to a second hydraulic motor volume;
wherein the pump volume command is configured to control the hydraulic pump to change the hydraulic pump volume at a second rate from a first pump volume to a second pump volume; and
wherein, in response to the shift command being an upshift command, the motor volume command is configured to control the hydraulic motor to decrease the hydraulic motor volume at the first rate from the first hydraulic motor volume to the second hydraulic motor volume, and the pump volume command is configured to control the hydraulic pump to decrease the hydraulic pump volume at the second rate from the first pump volume to the second pump volume, or wherein, in response to the shift command being a downshift command, the motor volume command is configured to control the hydraulic motor to increase the hydraulic motor volume at the first rate from the first hydraulic motor volume to the second hydraulic motor volume, and the pump volume command is configured to control the hydraulic pump to increase the hydraulic pump volume at the second rate from the first pump volume to the second pump volume.

2-5. (canceled)

6. The work vehicle of claim 1, wherein after the hydraulic pump volume is decreased from the first pump volume to the second pump volume, the pump volume command is configured to control the hydraulic pump to increase the hydraulic pump volume at a third rate from the second pump volume to the first pump volume, wherein the third rate is less than the second rate.

7-9. (canceled)

10. The work vehicle of claim 1, wherein after the hydraulic pump volume is increased from the first pump volume to the second pump volume, the pump volume command is configured to control the hydraulic pump to decrease the hydraulic pump volume at a third rate from the second pump volume to the first pump volume, wherein the third rate is less than the second rate.

11-13. (canceled)

14. A hydraulic shift control system, comprising:
a controller with a processor that executes computer executable instructions on a computer-readable medium, wherein the controller is configured to:
receive a shift command;
produce a motor volume command and a pump volume command in response to the shift command; and
shift a speed of a work vehicle from a first speed to a second speed by controlling a hydraulic motor volume of a hydraulic motor and a hydraulic pump volume of a hydraulic pump in response to the shift command;
wherein the motor volume command is configured to control the hydraulic motor to change the hydraulic motor volume at a first rate from a first hydraulic motor volume to a second hydraulic motor volume;
wherein the pump volume command is configured to control the hydraulic pump to change the hydraulic pump volume at a second rate from a first pump volume to a second pump volume; and
wherein, in response to the shift command being an upshift command, the motor volume command is configured to control the hydraulic motor to decrease the hydraulic motor volume at the first rate from the first hydraulic motor volume to the second hydraulic motor volume, and the pump volume command is configured to control the hydraulic pump to decrease the hydraulic pump volume at the second rate from the first pump volume to the second pump volume, or wherein, in response to the shift command being a downshift command, the motor volume command is configured to control the hydraulic motor to increase the hydraulic motor volume at the first rate from the first hydraulic motor volume to the second hydraulic motor volume, and the pump volume command is configured to control the hydraulic pump to increase the hydraulic pump volume at the second rate from the first pump volume to the second pump volume.

15. (canceled)

16. The hydraulic shift control system of claim 14, wherein after the hydraulic pump volume is decreased from the first pump volume to the second pump volume, the pump volume command is configured to control the hydraulic pump to increase the hydraulic pump volume at a third rate from the second pump volume to the first pump volume, wherein the third rate is less than the second rate.

17. (canceled)

18. The hydraulic shift control system of claim 14, wherein after the hydraulic pump volume is increased from the first pump volume to the second pump volume, the pump volume command is configured to control the hydraulic pump to decrease the hydraulic pump volume at a third rate from the second pump volume to the first pump volume, wherein the third rate is less than the second rate.

19-20. (canceled)

21. The hydraulic shift control system of claim 14, wherein the first rate is equal to the second rate.

22. The hydraulic shift control system of claim 14, wherein the pump volume command is configured to control the hydraulic pump to change the hydraulic pump volume from the first pump volume to the second pump volume at the same time as the hydraulic motor volume changes from the first hydraulic motor volume to the second hydraulic motor volume.

23. The work vehicle of claim 1, wherein the first rate is equal to the second rate.

24. The work vehicle of claim 1, wherein the pump volume command is configured to control the hydraulic pump to change the hydraulic pump volume from the first pump volume to the second pump volume at the same time as the hydraulic motor volume changes from the first hydraulic motor volume to the second hydraulic motor volume.

25. A hydraulic shift control system, comprising:
a controller with a processor that executes computer executable instructions on a computer-readable medium, wherein the controller is configured to:
receive a shift command;
produce a motor volume command and a pump volume command in response to the shift command; and
shift a speed of a work vehicle from a first speed to a second speed by controlling a hydraulic motor volume of a hydraulic motor and a hydraulic pump volume of a hydraulic pump in response to the shift command;
wherein the motor volume command is configured to control the hydraulic motor to change the hydraulic motor volume at a first rate from a first hydraulic motor volume to a second hydraulic motor volume;
wherein the pump volume command is configured to control the hydraulic pump to change the hydraulic pump volume at a second rate from a first pump volume to a second pump volume; and
wherein, in response to the shift command being a downshift command, the motor volume command is configured to control the hydraulic motor to increase the hydraulic motor volume at the first rate from the first hydraulic motor volume to the second hydraulic motor volume, the pump volume command is configured to control the hydraulic pump to decrease the hydraulic pump volume at the second rate from the first pump volume to the second pump volume, after the hydraulic pump volume is decreased from the first pump volume to the second pump volume, the pump volume command is further configured to control the hydraulic pump to maintain a constant output of the hydraulic pump for a period of time, and after the period of time, the pump volume command is further configured to control the hydraulic pump to increase the hydraulic pump volume at a third rate from the second pump volume to the first pump volume.

26. The hydraulic shift control system of claim 25, wherein the third rate is greater than the second rate.

27. The hydraulic shift control system of claim 25, wherein the first rate is equal to the third rate.

28. The hydraulic shift control system of claim 25, wherein the pump volume command is configured to control the hydraulic pump to increase the hydraulic pump volume from the second pump volume to the first pump volume at the same time as the hydraulic motor volume increases from the first hydraulic motor volume to the second hydraulic motor volume.
